(19) United States
(12) Patent Application Publication
(10) Pub. No.: US 2003/0055535 A1
(43) Pub. Date: Mar. 20, 2003

(54) Voice interface for vehicle wheel alignment system

(75) Inventors: David A. Voeller, Maryland Heights, MO (US); Timothy A. Strege, Ballwin, MO (US)

Correspondence Address: POLSTER, LIEDER, WOODRUFF & LUCCHESI, 763 SOUTH NEW BALLAS ROAD, ST. LOUIS, MO, 63141-8750, US

(73) Assignee: Hunter Engineering Company

(21) Appl. No.: 09/955,263

(22) Filed: Sep. 17, 2001

(51) Int. Cl. G10L 11/00

(52) U.S. Cl. 700/279; 33/286; 704/275

(57) ABSTRACT

An improved vehicle wheel alignment system having a voice audio interface. A system controller or central processing unit is configured with software to process voice audio signals received through an interconnected microphone, and to generate voice audio signals for delivery through a speaker, without the need for any preprocessing or intermediate processing by a voice command and speech processing card having a separate speech I/O processor.

### CROSS-REFERENCE TO RELATED APPLICATIONS

None.

### STATEMENT REGARDING FEDERALLY SPONSORED RESEARCH

Not Applicable.

### BACKGROUND OF THE INVENTION

The present invention relates generally to vehicle service systems having a computer configured to receive and convey information in voice format to be utilized in performing a vehicle service, and more particularly, to a vehicle wheel alignment system having a system controller configured to receiving operator voice instructions and to provide an operator with voice audio information related to vehicle wheel alignment procedures, including, but not limited to, alignment specifications, alignment measurements, and alignment procedure guidance.

Traditional vehicle wheel alignment systems utilize a system controller or central processor, typically a general purpose computer configured with wheel alignment software, which is connected to one or more vehicle wheel alignment angle sensors. General purpose computers, as utilized in vehicle wheel alignment systems typically include a variety of conventional input and output devices, such as keyboards, pointing devices, printers, displays, and audio components. Traditional vehicle wheel alignment sensors comprise angle transducers which are mounted to the wheels of a vehicle undergoing an alignment service, such as shown in U.S. Pat. No. 5,489,983 to McClenahan et al., but can comprise camera systems designed to observe either the wheels themselves, or targets mounted to the vehicle wheels, to generate images from which alignment angles may be determined, as shown in U.S. Pat. No. 5,870,315 to January.

In addition to requiring alignment information from individual wheel alignment sensors, a wheel alignment system or other vehicle service system central processor requires information identifying the type of sensors which it is utilizing, information related to the vehicle undergoing service, and information identifying the manner and format of any output provided to the operator or technician. These various pieces of information are traditionally entered into the central processor manually, via the conventional input devices such as the keyboard or mouse. During a vehicle wheel alignment procedure, a technician further interacts with the central processor by manually selecting choices presented by the central processor on a display, or by performing actions in response to directions provided on the display.

As manual entry of information and selection of choices can be time consuming and repetitive, it would be advantageous to provide a vehicle wheel alignment system wherein information can be exchanged between the operator or technician and the central processor in a voice audio form, thereby eliminating the need for the technician or operator to frequently return to the location of the display or manual data entry input devices.

U.S. Pat. No. 6,085,428 to Casby et al. for Hands Free Automotive Service System describes a voice control system for an automotive service system including a microphone, through which a technician can communicate voice commands to an item of automotive service equipment. Within the automotive service equipment, a speech processor module receives signals from the microphone, converts the voice commands into digital instructions which can be processed by a system controller, and additionally converts data from the system controller into synthesized voice audio for communication to the technician through an audio speaker.

As seen in prior art FIG. 1, the speech processor module of the '428 Casby et al. patent comprises a voice command and speech processing card which is plugged into a system data bus, separate from system controller or central processing unit (CPU). Analog voice signals received from a headset microphone are converted into digital signals which are then processed by a specialized digital signal processor, such as a Motorola DSP 56002 for comparison with a database of digital instructions. Digital instructions which correspond to the received and identified voice commands are then passed to the CPU over the system data bus. The CPU responds by performing a corresponding action. In voice generation mode, the speech processing card can generate audio signals by playing back pre-recorded voice messages stored in memory, or alternatively, can be adapted to convert digital data received from the CPU on the system bus into synthesized voice audio signals, which are then transmitted to a speaker. In this manner, voice commands spoken by the technician into a headset microphone can be used to operate the automotive service system and information and data generated by the system can be presented to the technician through a speaker.

Recently, the vehicle service industry has seen an increase in the use of powerful portable computers, such as personal desktop assistances (PDA's), laptop computers, and the introduction of small-footprint general purpose computers, many of which have completely eliminated or reduced the number of available traditional expansion slots providing interfaces to a system data bus. Accordingly, there is a need for vehicle wheel alignment systems which utilize a voice audio interface to communicate with a vehicle service technician, and for vehicle wheel alignment systems which do not require a separate voice command and speech processing card or separate voice command processor. It has further been found that the use of a headset microphone is cumbersome to a vehicle service technician who may be frequently required to operate within the confined space underneath a vehicle raised on a lift rack. Accordingly, there is a need for a voice audio vehicle wheel alignment system which is capable of distinguishing operator voice commands from ambient and transient background noise without the need for a headset mounted microphone.

### BRIEF SUMMARY OF THE INVENTION

Briefly stated, the present invention improves on vehicle wheel alignment systems having voice audio interfaces by providing a system controller or central processing unit configured with software to process voice audio signals received through an interconnected microphone, without the need for any voice preprocessing or intermediate processing by a voice command and speech processing card having a separate speech I/O processor configured to identify one or more digital commands corresponding to the received voice audio signal.

In a first alternate embodiment, the present invention improves on vehicle wheel alignment systems having voice audio interfaces by providing one or more microphones remotely located from an operator for receiving voice audio signals and ambient noise. Signals received from each microphone are processed to improve reception of voice audio commands, for example by reducing ambient noise present in the voice audio signal or by tracking an operator who is moving while providing a voice command.

In a second alternate embodiment, the system controller or central processing unit of the vehicle wheel alignment system is further configured with software to process context sensitive voice audio signals received through an interconnected microphone, such that a voice audio command received during one operational phase of a wheel alignment procedure will result in the central processing unit performing a first function, while the same voice audio command received during a second operation phase will result in the central processing unit performing a second function.

In a third alternate embodiment, the system controller or central processing unit of the vehicle wheel alignment system is further configured with software to process a limited vocabulary of phonetically different voice audio signals received through an interconnected microphone, such that the accuracy and speed of recognition of individual voice commands is improved.

In a fourth alternate embodiment, the system controller or central processing unit of the vehicle wheel alignment system is further configured with software to generate, in response to system inputs or to convey information to an operator, voice audio signals for transmission to a speaker. The system controller or central processing unit is configured to generate these voice audio signals without the use of a voice command and speech processing card having a separate speech I/O processor.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a block diagram of a prior art automotive service system including a speech I/O processor module linked to a central processing unit via a system bus;

FIG. 2 is a block diagram of a vehicle wheel alignment service system of the present invention, configured to provide voice audio I/O without a speech I/O processor linked to a central processing unit via the system bus;

FIG. 3 is a simplified illustration of the use of two microphones for background noise subtraction; and

FIG. 4 is a simplified illustration of the use of a beam forming array of microphones for eliminating undesired noise signals.

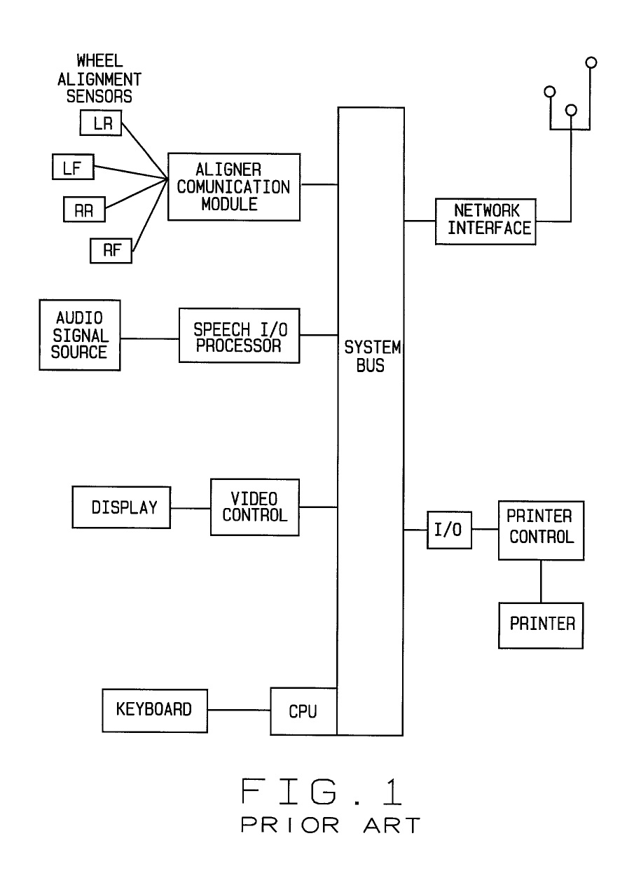

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

Turning to the figures, there is shown the components of a conventional vehicle wheel alignment system generally at 10. The vehicle alignment system 10 includes at least one input device 12, such as a keyboard 12A, a mouse 12B, or a touch screen 12C, for use by an operator or technician (not shown) to communicate with the vehicle alignment system 10, and at least one output device 14, such as a display 14A or printer 14B for the alignment system 10 to convey information to the operator or technician. Depending upon the needs of the operator or technician, the input devices 12 and output devices 14 can be integrated together in a central console, in a portable device, or located separately, again depending upon the needs of the operator and the configuration of the wheel alignment system 10.

The input devices 12 and output devices 14 are in communication with a computing device 16 such as a wheel alignment computer, operating under control of one or more software programs or software objects. The computing device 16 can be any computing device used with systems of complexity similar to that of a vehicle wheel alignment system. For example, a micro-processor, a micro-controller, a digital signal processor having sufficient computing power, or a general purpose computer can be used as the computing device. Of course, any equivalent device, i.e. one capable of executing the requisite software programs or software objects, can also be used, however, the present invention is particularly suitable for use with portable devices, such as Personal Desktop Assistants (PDAs) or laptop computers which have limited resources for peripheral hardware components.

Communication between the input devices 12, output devices 14, and the computing device 16 can be performed electronically or electro-magnetically (including optical communications such as an infrared system), or by any combination thereof. The computing device 16 of the vehicle wheel alignment system 10 is additionally in communication with one or more sensing devices 18 for obtaining measurements of the various alignment angles and/or characteristics of a vehicle under test, such as those shown in U.S. Reissue Pat. No. 33,144 to Hunter etal., U.S. Pat. No. 5,598,357 to Colarelli et al, and U.S. Pat. No. 4,381,548 to Grossman et al., the disclosures of which are incorporated herein by reference.

The sensing devices 18, depending upon the application and requirements, can be electronic, electromechanical, or active or passive optical alignment targets such as those disclosed in U.S. Pat. No. 5,535,522 to Bernie F. Jackson, and U.S. Pat. No. 5,675,515, to Daniel B. January. The sensing devices 18 can be hard-wired to the computing device 16 for communication therewith, or can be in communication with the computing device 16 in any other suitable manner, such as through infrared, optical, or radio-frequency communication.

In addition to the input devices 12, output devices 14, and sensing devices 18, the computing device 16 of the vehicle wheel alignment system 10 can be configured with access to an internal or external data storage component (collectively identified as 20), and to various peripheral components, such as digital cameras, and/or a communications network such as the Internet or a local micro-network.

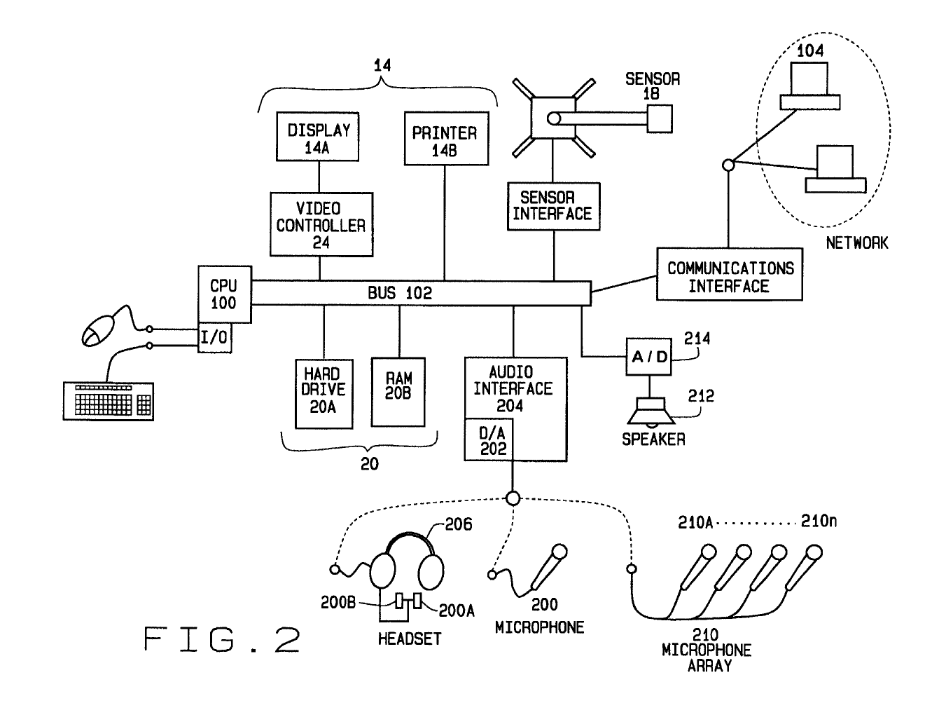

Turning to FIG. 2, a preferred embodiment of the computing device 16 is shown. A central processing unit 100 is in communication with a system bus 102, through which data is exchanged with one or more peripheral components, such as a display 14A, a printer 14B, sensing devices 18, a hard drive 20A and random access memory 20B.

Data exchange between the central processing unit and the various peripheral components linked to the system bus typically takes place through an associated control module. For example, a video control module 24, which includes a conventional video display controller, such as a VGA, XGA, or SXGA controller is disposed between the system bus 102 and the display unit 14A. The display unit 14A is preferably a CRT computer monitor display, but may be an LCD display or other display configured to receive information from a computer for visual presentation to a user. Similarly, a sensor interface module may be disposed between the sensing devices 18 and the system bus 102 to regulate the communication of data to and from the sensing devices 18. Connections to external systems, such as a local area network 104, or the Internet may be established though a suitable communications module 106 linked to the system bus 102, while some input devices 12, such as the keyboard 12A or mouse 12B are linked directly to the central processing unit 100 without requiring a link to the system bus 102.

In the present invention, one or more microphones 200 or similar devices configured to receive voice audio input from an operator are in communication with the central processing unit 100. The microphones 200 do not communicate with the central processing unit through an associated speech analysis card, and voice audio signals received at the microphones are not pre-processed or parsed for individual commands or other predetermined patterns prior to being received at the central processing unit 100. However, those of ordinary skill in the art will recognize that voice audio signals received in analog form may be converted into digital form by means of conventional analog-to-digital conversion circuits 202 contained in an audio interface module 204 without pre-processing or parsing the voice audio signals to identify individual commands. The audio interface module 204 may either be associated directly with the microphones 200 or may be associated with the computing device 16 containing the central processing unit 100.

Received voice audio signals, either in digital or analog form, may be conditioned using spectral subtraction techniques, filtered, or analyzed by the audio interface module 204 to remove ambient or background noise and to clarify voice audio frequencies, thereby facilitating parsing and command recognition by the central processing unit 100. Voice audio commands are received at the one or more microphones 200, together with ambient and transient background noises. The microphones 200 may be either analog microphones, which convey an analog signal to the audio interface module 204 for conversion to digital format, or may be digital microphones, such as the Solution-D microphone manufactured by Neumann USA, which provide a digital representation of a received voice audio signal to the audio interface module 204.

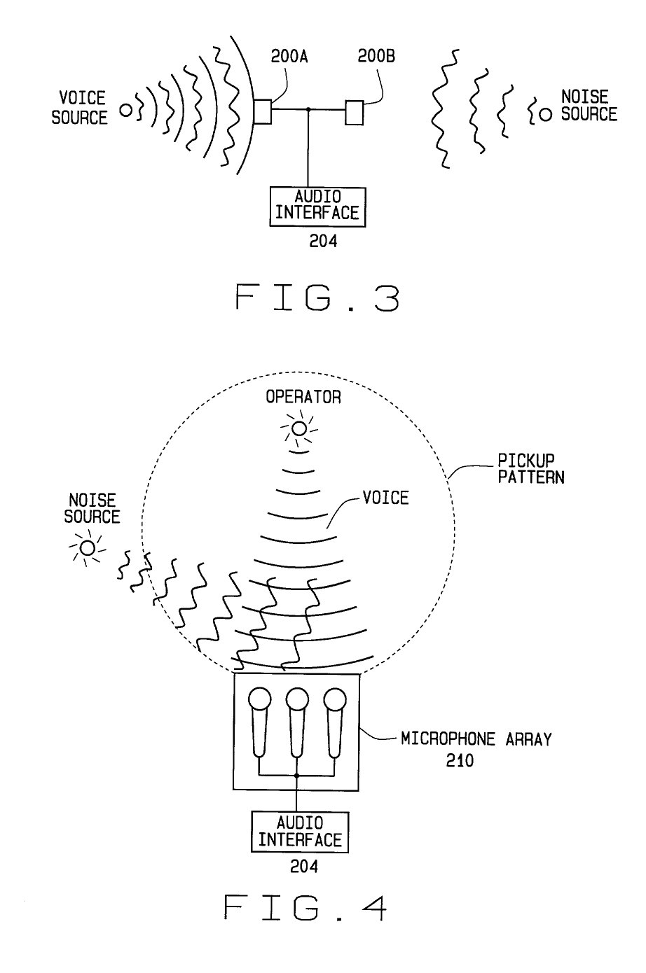

When signals are received at the audio interface module 204 from more than one microphone 200, the audio interface module 204 is configured to process the received signals to reduce undesired noise in the signal from ambient and transient background sounds present in the microphone environment. For example, as seen in FIG. 3, two unidirectional microphones 200A and 200B may be provided for the operator in a wearable headset 206. The first microphone 200A is positioned to primarily receive voice commands spoken by the operator, while the second microphone 200B is positioned to primarily receive background ambient and transient noises, preferably facing in the opposite direction the first microphone 200A. The signal representing ambient noises received at the second microphone 200B is utilized by the audio interface module 204 to compensate the signal representing noises received at the first microphone 200A, thereby providing a clearer representation of the spoken voice audio commands.

Due to the cumbersome nature of using a microphone headset in an automotive service environment, an alternate embodiment of the present invention utilizes one or more unidirectional microphones 200 with pickup paths configured to received sounds within a predetermined vehicle service area. For example, a microphone 200 may be placed at the front of a vehicle service lift rack. A second microphone 200 may be positioned to face an opposite direction, for purposes of providing a signal which is utilized in reducing ambient and transient noise signals, as previously described.

Similarly, an additional alternate embodiment of the present invention utilizes an auto-directive microphone array 210, such as the Andrea DA-400 Desktop Array Microphone sold by Andrea Electronic Corp. of Melville, N.Y. Specifically, a beam-forming microphone array 210 is used wherein multiple microphones 210A-210n, where n is a variable, are positioned in proximity to a vehicle service area. The received audio signals from each individual microphone 210A-210n are processed mathematically by the audio interface module 204 to determine the shape of the overall audio pickup pattern and to cancel out all received sounds from noise sources outside of the pickup pattern, thereby filtering the speaker's voice. Beam-forming microphone arrays 210 take advantage of the fact that the sound of a operator's voice takes a slightly different amount of time to reach each of the microphones 210A-210n in the array 210. Ambient and transient background sounds arrive at each of the microphones 210A-210n in a different order than the operator's voice, and are cancelled out by digital processing.

Auto-directive microphone arrays 210 have the ability to track a moving operator or to locate and orientate towards an operator within the overall audio pickup pattern. Tracking a moving operator is a particularly useful feature for automotive service, as an operator is likely to move around a vehicle undergoing service while issuing voice commands to the system.

Alternatively, microphone array 210 may be configured as a blind source separation microphone array. A blind source separation microphone array is configured to exploit microphone differential information and the statistical properties of independent signal sources to isolate a voice signal of interest.

To provide voice audio output to the operator, one or more audio speakers 212 or similar devices configured to receive audio signals from the central processing unit 100 for conversion into audio sounds audible to an operator are in communication with the central processing unit 100. The audio speakers 212 do not communicate with the central processing unit through an associated control module, and audio signals received at the audio speakers are not processed to identify voice audio components prior to the conversion into audio sounds. However, those of ordinary skill in the art will recognize that audio signals received at the speakers in digital form may be converted to analog form by means of conventional digital-to-analog conversion circuits 214 without additional processing to identify voice audio components.

Turning again to the preferred embodiment, the central processing unit 100 is configured with one or more software objects. Individual software objects may be adapted to facilitate operation of various components of the vehicle wheel alignment system, such as interpreting data received from the sensing devices 18, directing the display of information to said display 14A, or communicating with external systems 104. At least one software object is adapted to process voice audio input signals received from the microphone 200 to identify one or more commands, instructions, or predetermined phrases contained within the voice audio input signal. The voice audio input processing software module is adapted to identify predetermined individual words or phrases contained in the voice audio input signals, and to provide the central processing unit 100 with one or more commands or instructions associated with said predetermined individual words or phrases. The central processing unit 100 is further configured to either execute the received commands or instructions, or to provide one or more suitable instructions to an appropriate peripheral component of the vehicle wheel alignment system.

In one alternate embodiment, the software objects with which the central processing unit 100 is configured utilize the VoiceXML (Voice extensible Markup Language) standard to identify commands, instructions, or predetermined phrases contained in the received voice audio input signals, and to provide the central processing unit 100 with one or more commands or instructions associated with the voice signal processed commands, instructions, or predetermined phrases. The VoiceXML Version 1.0 standard, herein incorporated by reference, provides a framework around which voice audio signal processing is performed, establishing standard input and output protocols, event handling (such as intelligible voice audio signals, requests for help, etc), and communications. VoiceXML is adapted to work in conjunction with Internet Browser based applications to provide voice audio interfaces, the use of VoiceXML is particularly suited for vehicle wheel alignment applications wherein the central processing unit 100 is configured with an Internet browser-based user interface for processing and/or displaying vehicle wheel alignment information.

With a central processing unit 100 configured in this manner, an operator can direct the operation of the vehicle wheel alignment system using spoken voice commands as input, eliminating the need to manually enter commands via the keypad 12A, pointing device 12B, or other input device 12. For example, an operator speaking into the microphone 200 may state individual commands such as “BEGIN”, “STOP”, “CONTINUE”, “SELECT”, “NEXT” or “DISPLAY”. Alternatively, the operator could state a command to the vehicle wheel alignment system in the form of a phrase, such as “DISPLAY ALIGNMENT VIDEO”, “BEGIN RUNOUT COMPENSATION”, “READ INSTRUCTIONS”, “ACQUIRE MEASUREMENTS”, or “DISPLAY ALIGNMENT SPECIFICATIONS”. Those of ordinary skill in the art will recognize that there is a wide range of individual commands and phases which the voice audio input software module can be configured to identify in a voice audio input signal.

It is known to require an operator to preface voice audio commands with a specific “wake-up” or trigger word. The trigger word is then followed by a spoken instruction. For example, the phrase “ALIGNER, DISPLAY ALIGNMENT SPECIFICATIONS” may be utilized to instruct a vehicle wheel aligner to provide the operator with a display of alignment specifications. Using this conventional format for delivery of voice audio commands to a system, the operator is required to preface each command with the “wake-up” or trigger word. The purpose of the “wake-up” or trigger word is to prevent the vehicle wheel aligner from interpreting portions of non-command conversations carried out within the audio pickup range of the vehicle wheel aligner as spoken commands.

In one embodiment of the present invention, to facilitate the recognition of individual voice commands by the central processing unit 100, the set of predefined commands and phrases may be selected such that each command or phrase is phonetically distinct. The use of phonetically distinct voice audio commands and phrases reduces the possibility of one command or phrase being incorrectly interpreted by the central processing unit 100 as another command which sounds phonetically similar. A further reduction in the occurrence of incorrect command interpretations may be achieved by utilizing command words or phrases which are not part of everyday speech, thereby eliminating the requirement for a “wake-up” or trigger word to preface every spoken command.

It is preferred that each predetermined individual command or phrase is associated with at least one command, instruction, or sequence of instructions which is then communicated to the central processing unit 100 by the voice audio input software module upon identification of the corresponding individual command or phrase. The associated commands or instructions may be context sensitive, such that a voice audio command received during one operational phase of a wheel alignment procedure will result in the central processing unit 100 performing a first function, while the same voice audio command received during a second operational phase will result in the central processing unit 100 performing a second function. Operational context or operational state information may be stored in the memory 20B accessible by the central processing unit 100, and retrieved as is required upon receipt of a command or instruction from the voice audio input software object.

For example, a table stored in the memory 20B may identify one or more operational states or contexts, with associated functions identified for each, in which a voice audio command may be received. If a voice audio command is received by the system in an operational state or context where such a command is inappropriate or a response is not defined, the central processing unit 100 may be configured to respond with an error message to the operator, identifying the nature of the error or requesting clarification of the received command.

In an alternate embodiment, the central processing unit 100 is configured with a voice audio output software object adapted to generate voice audio signals for output to an operator through one or more speakers 212 or similar audio output devices. The central processing unit 100 utilizes the voice audio output software object to convey information or instructions to an operator in conjunction with information conveyed in a traditional manner on a display, or independently thereof. For example, the voice audio output software object may be adapted to generate voice audio identifying one or more alignment angle measurements as calculated by the central processing unit 100.

Those of ordinary skill in the art will readily recognize that the voice audio input software object and the voice audio output software object may internally consist of a plurality of sub-component software objects, or may be combined in the form of a single voice audio processing software module capable of processing both input and output voice audio signals.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. In combination with a vehicle wheel alignment system having a central processing unit for controlling the operation of the vehicle wheel alignment system, an improvement which comprises:
said central processing unit configured with at least one software object adapted to process data representative of voice audio input to identify one or more spoken commands;
wherein said central processing unit is responsive to said software object to control the operation of at least one component of said wheel alignment system in response to one or more spoken commands contained in said voice audio input.

2. The system of claim 1 wherein said at least one software object is configured to utilize VoiceXML to process said data representative of said voice audio input to identify one or more spoken commands; and
wherein said at least one software object is further configured to utilize VoiceXML to translate said identified one or more spoken commands into operating instructions.

3. The system of claim 1 wherein said central processing unit is responsive to said software object to control the operation of a display in response to one or more spoken commands contained in said voice audio input.

4. The system of claim 3 wherein said voice audio input contains at least one request for information, and wherein said central processing unit is responsive to said software object to control the operation of said display to present said requested information.

5. The system of claim 1 wherein said at least one software object is configured to parse data representative of voice audio input and to extract from said data one or more commands for said central processing unit.

6. The system of claim 1 wherein each of said spoken commands are phonetically distinct.

7. The system of claim 1 further including at least one microphone adapted to receive voice audio, said at least one microphone disposed remotely from an operator and configured to produce a signal representative of said received voice audio for communication to said central processing unit.

8. The system of claim 1 further including:
a first microphone positioned to primarily receive voice audio, said first microphone configured to produce a first signal representative of received voice audio input;
a second microphone positioned to primarily receive ambient and transient background audio, said second microphone configured to produce a second signal representative of received ambient and transient background audio; and
an audio processor module configured to receive said first and second signals and to provide data representative of voice audio input to said central processing unit, said audio processor module further adapted to utilize said first signal and said second signal to clarify voice audio input.

9. The system of claim 8 wherein said first and second microphones are mounted to a headset.

10. The system of claim 8 wherein said first and second microphones are positioned to receive sounds from within a predetermined area.

11. The system of claim 8 wherein said first and second microphones are unidirectional.

12. In combination with a vehicle wheel alignment system having a central processing unit for controlling the operation of the vehicle wheel alignment system, an improvement which comprises:
said central processing unit configured to identify one or more spoken commands from received voice audio input;
said central processing unit further configured to identify an operational context in which a voice audio input is received; and
wherein said central processing unit is responsive to said one or more identified spoken commands and to said identified operational context to control the operation of at least one component of said wheel alignment system.

13. In combination with a vehicle wheel alignment system having a central processing unit for controlling the operation of the vehicle wheel alignment system, an improvement which comprises:
said central processing unit configured to identify one or more spoken commands from received voice audio input;
a plurality of microphones, each of said microphones receiving sounds including operator voice audio, ambient background noise, and transient background noise, and each of said microphones configured to produce a signal representative of said received sounds; and
an audio processor module disposed between said central processing unit and said plurality of microphones, said audio processor module configured to receive and combine each of said signals from said plurality of microphones and to extract voice audio input from said combined signals to provide data representative of said voice audio input to said central processing unit.

14. The system of claim 13 wherein said plurality of microphones defines a beam-forming microphone array.

15. The system of claim 13 wherein said audio processor module is further configured to utilize said combined signals to track movement of an operator.

16. The system of claim 13 wherein said plurality of microphones defines a blind source separation microphone array.

17. In combination with a vehicle wheel alignment system having a central processing unit for controlling the operation of the vehicle wheel alignment system, an improvement which comprises:
said central processing unit configured with at least one software object adapted to generate at least one voice audio output signal; and
wherein said central processing unit is responsive to said software object to communicate said generated voice audio signal to an audio output device.

18. A method for controlling a vehicle wheel alignment system having a central processing unit configured with at least one software object for processing voice audio signals, at least one alignment angle sensor, a display, and a microphone, comprising:
receiving, at said microphone, at least one voice audio command;
communicating said at least one voice audio command from said microphone to said software object;
processing, with said at least one software object, said communicated voice audio command; and
responsive to said processing of said voice audio command, said central processing unit performing one or more actions.

19. The method for controlling a vehicle wheel alignment system of claim 18 wherein responsive to said processing of said voice audio command, said central processing unit presents alignment angle information to an operator on said display.

20. The method for controlling a vehicle wheel alignment system of claim 18 wherein responsive to said processing of said voice audio command, said central processing unit presents alignment angle adjustment instructions to an operator on said display.

21. The method for controlling a vehicle wheel alignment system of claim 18 wherein responsive to said processing of said voice audio command, said central processing unit directs at least one software object to generate a voice audio response for communication to an operator via an audio speaker.

22. The method for controlling a vehicle wheel alignment system of claim 18 wherein the step of communicating further includes the step of clarifying said voice audio command by reducing ambient noise and transient noise accompanying said voice audio command.

23. A method for controlling a vehicle wheel alignment system having a central processing unit configured for processing voice audio signals, at least one alignment angle sensor, a display, and at least one microphone, comprising:
receiving, at said at least one microphone, one or more voice audio commands;
communicating said one or more voice audio commands from said at least one microphone to said central processing unit;
processing said communicated one or more voice audio commands;
identifying a current operating context for said vehicle wheel alignment system;
associating one or more actions corresponding to said current operating context with said communicated one or more voice audio commands; and
responsive to said association, said central processing unit performing said one or more actions.

24. A method for controlling a vehicle wheel alignment system having a central processing unit configured with at least one software object for processing voice audio signals, at least one alignment angle sensor, a display, a first microphone, and at least one additional microphone, comprising:
receiving, at said first microphone, at least one voice audio command together with ambient noise;
generating, at said first microphone, a first audio signal representative of said at least one voice audio command together with ambient noise;
receiving, at said at least one additional microphone, said ambient noise;
generating, at said at least one additional microphone, at least one additional audio signal representative of said ambient noise;
clarifying a portion of said first audio signal representative of said at least one voice audio command by utilizing said at least one additional audio signal;
communicating said clarified portion of said first audio signal representative of said at least one voice audio command to said software object;
processing, with said at least one software object, said communicated signal; and
responsive to said processing of said signal, said central processing unit performing one or more actions.

25. A method for controlling a vehicle wheel alignment system having a central processing unit configured for processing voice audio signals, at least one alignment angle sensor, a display, and at least one microphone, comprising:
receiving, at said at least one microphone, one or more voice audio commands from a predetermined set comprising phonetically distinct voice audio commands;
communicating said one or more received voice audio commands from said at least one microphone to said central processing unit;
processing said communicated voice audio commands;
associating one or more actions with said processed voice audio commands; and
responsive to said association, said central processing unit performing said one or more actions.
